(19) United States
(12) Patent Application Publication
(10) Pub. No.: US 2018/0265192 A1
(43) Pub. Date: Sep. 20, 2018

(54) AERIAL VEHICLE OPERATION SYSTEM AND CRANE DEVICE CONTROL METHOD

(71) Applicant: FUJITSU LIMITED, Kawasaki-shi (JP)

(72) Inventors: Hiroshi YAMAGAMI, Yokohama (JP); Manabu NAKAO, Kunitachi (JP); Yoshiro HADA, Atsugi (JP)

(73) Assignee: FUJITSU LIMITED, Kawasaki-shi (JP)

(21) Appl. No.: 15/896,611

(22) Filed: Feb. 14, 2018

(30) Foreign Application Priority Data
Mar. 14, 2017 (JP) 2017-048754

(51) Int. Cl. B64C 39/02; B66C 13/48; G05D 1/10; G05D 1/00; B66C 13/46

(52) U.S. Cl. CPC B64C 39/022; B64C 39/024; B66C 13/48; B66C 23/205; G05D 1/0055; B66C 13/46; G05D 1/0033; G05D 1/101

(57) ABSTRACT

An aerial vehicle operation system includes an unmanned aerial vehicle in which a cable is connected, a processor, a fulcrum position adjustment mechanism, and a cable winding device. The processor determines a fulcrum position at which to support the cable to be above the unmanned aerial vehicle and to be on an extended line in a direction within a prescribed scope of angles with respect to a reference extension direction in the unmanned aerial vehicle. The processor determines control information about an operation of an arm of a crane that changes a position of a cable support included in the crane, and a length of a cable from the fulcrum position to the unmanned aerial vehicle. The fulcrum position adjustment mechanism controls an operation of the arm using the control information. The cable winding device changes a length of the cable using the determined length of the cable.

### CROSS-REFERENCE TO RELATED APPLICATION

This application is based upon and claims the benefit of priority of the prior Japanese Patent Application No. 2017-048754, filed on Mar. 14, 2017, the entire contents of which are incorporated herein by reference.

### FIELD

The embodiments discussed herein are related to an aerial vehicle operation system, a crane device control method and a control program.

### BACKGROUND

In recent years, accompanying the improvement of techniques related to unmanned aerial vehicles that are known as drones and the increase in the spread thereof, unmanned aerial vehicles are expected to be applied to a variety of scenes. In for example inspection services of various types of structures such as roads, buildings, etc., while demand for maintenance and management due to aging of structures is increasing, there is a problem of labor shortages etc. The utilization of unmanned aerial vehicles is expected to improve the efficiency of such inspection services.

Because an unmanned aerial vehicle flies through remote control or in an autonomous manner, an unexpected event during the flight sometimes forces the unmanned aerial vehicle into an uncontrollable or unflyable state, leading to a crash. As a method of reducing damage caused by crashing of unmanned aerial vehicles, a method is known in which a floating body such as a balloon etc. suspends an intermediate portion, in the longitudinal direction, of the cable connecting the unmanned aerial vehicle and the ground facility so that the unmanned aerial vehicle is flown stably (see Patent Document 1 for example).

Patent Document 1: Japanese Laid-open Patent Publication No. 2016-179742

### SUMMARY

According to an aspect of the embodiment, an aerial vehicle operation system includes an unmanned aerial vehicle in which a cable is connected to a surface facing upward during flight in a correct orientation, a memory, a processor, a fulcrum position adjustment mechanism, and a cable winding device. The processor is connected to the memory. The processor collects flight position and orientation of the unmanned aerial vehicle. The processor determines, based on the flight position and orientation of the unmanned aerial vehicle, a fulcrum position at which to support the cable to be above the unmanned aerial vehicle and to be on an extended line in a direction within a prescribed scope of angles with respect to a reference extension direction in the unmanned aerial vehicle. The processor determines, based on the determined fulcrum position, control information about an operation of an arm in a crane device that includes a cable support supporting the cable and the arm changing a position of the cable support. The processor determines a length of a cable from the fulcrum position to a connection position of the cable in the unmanned aerial vehicle based on a positional relationship between the determined fulcrum position and the connection position of the cable in the unmanned aerial vehicle and based on a positional relationship between the connection position of the cable in the unmanned aerial vehicle and a rotation region of a rotor blade of the unmanned aerial vehicle. The fulcrum position adjustment mechanism controls an operation of the arm based on the determined control information about an operation of the arm. The cable winding device changes, based on the determined length of the cable, a length of the cable provided from the cable support.

The object and advantages of the embodiment will be realized and attained by means of the elements and combinations particularly pointed out in the claims.

It is to be understood that both the foregoing general description and the following detailed description are exemplary and explanatory and are not restrictive of the embodiment.

### BRIEF DESCRIPTION OF DRAWINGS

FIG. 1 illustrates a system configuration of an aerial vehicle operation system according to an embodiment;

FIG. 2 illustrates a configuration of a crane device according to an embodiment;

FIG. 3 illustrates a functional configuration of a control device;

FIG. 4 is a plan view explaining a relationship between the rotation regions of rotor blades in the unmanned aerial vehicle and the cable connection position;

FIG. 5 is a front view explaining a relationship between the rotation regions of rotor blades in the unmanned aerial vehicle and an extension direction of the cable;

FIG. 6 is a flowchart explaining a control method of a crane device according to an embodiment;

FIG. 7 explains operations of a crane device in a case when the unmanned aerial vehicle is moved in vertical directions;

FIG. 8 explains a situation that may occur when arms do not follow horizontal movements of the unmanned aerial vehicle;

FIG. 9 explains operations of the crane device in a case when the unmanned aerial vehicle moves in horizontal directions in the aerial vehicle operation system according to an embodiment;

FIG. 10 explains a variation example of the configuration of the crane device;

FIG. 11 illustrates a functional configuration of a control device according to the variation example; and

FIG. 12 illustrates a hardware configuration of a computer.

### DESCRIPTION OF EMBODIMENTS

When a floating body suspends a portion that is halfway in the longitudinal direction of the cable connecting a unmanned aerial vehicle and a ground facility as described above, slack sometimes emerges in the cable between the unmanned aerial vehicle and the floating body. Contact between a cable involving slack and a rotor blade of the unmanned aerial vehicle may hinder the unmanned aerial vehicle from flying stably.

Preferred embodiments of the present invention will be explained with reference to accompanying drawings. The aerial vehicle operation system that will be explained below is a system that picks up an image of a wall surface of a structure by using an unmanned aerial vehicle that can fly through remote control.

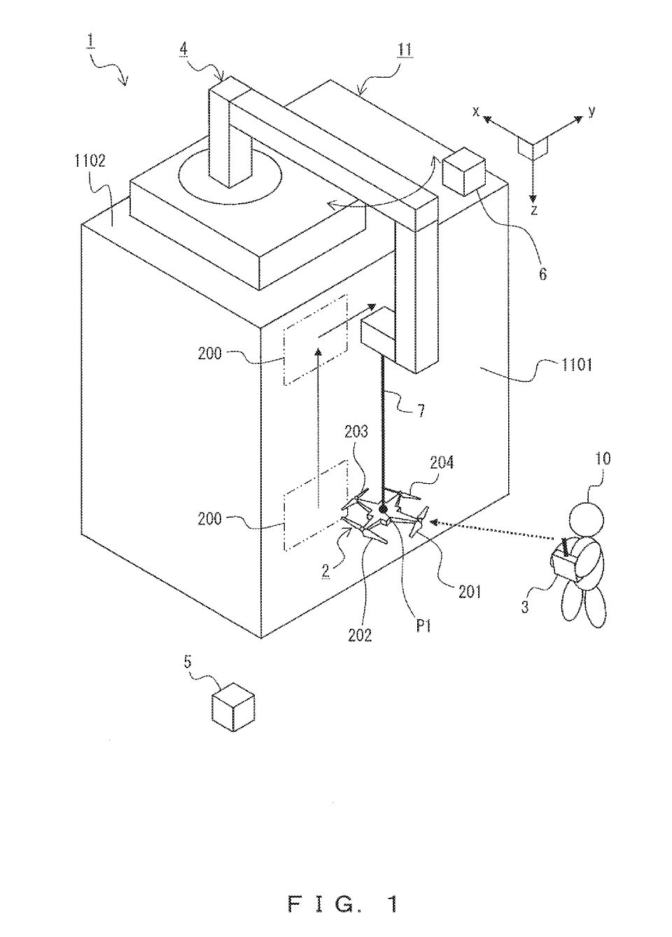

FIG. 1 illustrates a system configuration of an aerial vehicle operation system according to an embodiment.

As illustrated in FIG. 1, an aerial vehicle operation system 1 includes an unmanned aerial vehicle 2, a manipulation unit 3, a crane device 4, a position detection device 5, and a wind direction and speed detection device 6.

The unmanned aerial vehicle 2 is an aerial vehicle that can fly through remote control (radio control) utilizing the manipulation unit 3. The unmanned aerial vehicle 2 includes for example an image-pickup device and an orientation detection device (not illustrated) attached to it. The present embodiment explains an aerial vehicle (multicopter) having a plurality of rotor blades 201, 202, 203 and 204, as an example of the unmanned aerial vehicle 2. The controlling person 10 for the aerial vehicle operation system 1 manipulates the manipulation unit 3 so as to move the unmanned aerial vehicle 2 in the vertical and horizontal directions along a wall surface 1101 of a structure 11. In doing so, the controlling person 10 controls the unmanned aerial vehicle 2 in such a manner that for example an image pickup scope 200 of the image pickup device attached to the unmanned aerial vehicle 2 moves over the entirety of the surface 1101 of the structure 11 in a manner of raster scanning.

Also, the orientation detection device attached to the unmanned aerial vehicle 2 uses a known detection method so as to detect the orientation of the unmanned aerial vehicle 2 during its flight. The orientation detection device transmits information indicating the orientation of the unmanned aerial vehicle 2 to the crane device 4.

The crane device 4 adjusts a positional relationship between a fulcrum position on the crane device 4 side and fulcrum position P1 on the unmanned aerial vehicle 2 side in a cable 7 connected to the unmanned aerial vehicle 2, and also adjusts the length of the cable 7 between the fulcrums (which will be referred to as “a provided cable length”). Based on the flight position and orientation of the unmanned aerial vehicle 2, the wind direction and wind speed in the environment surrounding the unmanned aerial vehicle 2 (flight environment), and other factors, the crane device 4 adjusts the provided cable length and the extension direction of the cable 7. The flight position of the unmanned aerial vehicle 2 is detected by the position detection device 5 installed in the vicinity of the structure 11. The orientation of the unmanned aerial vehicle 2 is detected by an orientation detection device (not illustrated) provided to the unmanned aerial vehicle 2. The wind direction and wind speed in the environment surrounding the unmanned aerial vehicle 2 is detected by the wind direction and speed detection device 6 installed in the vicinity of the structure 11. The crane device 4 collects the flight position and orientation of the unmanned aerial vehicle 2, the wind direction and wind speed in the environment surrounding the unmanned aerial vehicle 2, etc. by a control device (not illustrated), and adjusts the fulcrum position of the cable 7 and the provided cable length.

The position detection device 5 detects the flight position of the unmanned aerial vehicle 2 in accordance with a known detection method. For example, the position detection device 5 uses a laser beam to detect the direction and distance of the unmanned aerial vehicle 2 seen from the position detection device 5, and calculates the flight position of the unmanned aerial vehicle 2 in the world coordinate system. The position detection device 5 conducts wireless or wired communications with the crane device 4 so as to transmit information indicating the flight position of the unmanned aerial vehicle 2 to the crane device 4.

The wind direction and speed detection device 6 uses a known detection method to detect the wind direction and wind speed in the vicinity of the structure 11. The wind direction and speed detection device 6 conducts wireless or wired communications with the crane device 4, and transmits information indicating the wind direction and the wind speed to the crane device 4.

In the aerial vehicle operation system 1 according to the present embodiment, the crane device 4 is installed at a position that is on the side higher than the unmanned aerial vehicle 2 such as a roof 1101 of the structure 11 etc. so that the crane device 4 supports the cable 7 connected to the unmanned aerial vehicle 2. The crane device 4 adjusts the fulcrum position of the cable 7 and the provided cable length based on the flight position and orientation of the unmanned aerial vehicle 2 and the state of the wind in the environment surrounding the unmanned aerial vehicle 2. In doing so, the crane device 4 adjusts the provided cable length in such a manner that slack emerging in the cable 7 is smaller than a prescribed slack amount, based on the distance between the fulcrum position on the crane device 4 side and the connection position with the cable 7 in the unmanned aerial vehicle 2. For example, the crane device 4 adjusts the provided cable length in such a manner that an angle is within a prescribed scope, the angle being between the extension direction of the cable 7 in the vicinity of the fulcrum position on the unmanned aerial vehicle 2 side and the vertically upward direction in the unmanned aerial vehicle 2 while the unmanned aerial vehicle 2 is in a correct orientation. In this example, a correct orientation of the unmanned aerial vehicle 2 is an orientation in which the orientation detection device (such as a gyro sensor for example) of the unmanned aerial vehicle 2 detects that the unmanned aerial vehicle 2 is not inclined. In other words, when the orientation of the unmanned aerial vehicle 2 is inclined, the vertically upward direction in the unmanned aerial vehicle 2 assuming that it is in a correct orientation changes in response to the angle of the inclination. Also, an angle between the extension direction of the cable 7 and the vertically upward direction in the unmanned aerial vehicle 2 assuming that it is in a correct orientation is made smaller than the angle at which the cable 7 comes into contact with a rotor blade of the unmanned aerial vehicle 2. Thereby, the unmanned aerial vehicle 2 falling in an unflyable state for example enters a state in which it is suspended from the crane device 4 via the cable 7, preventing the crashing etc. of the unmanned aerial vehicle 2. Also, adjusting the fulcrum position of the cable 7 and the provided cable length in the crane device 4 prevents a situation in which the cable 7 is wound on a rotor blade of the unmanned aerial vehicle 2 during the flight.

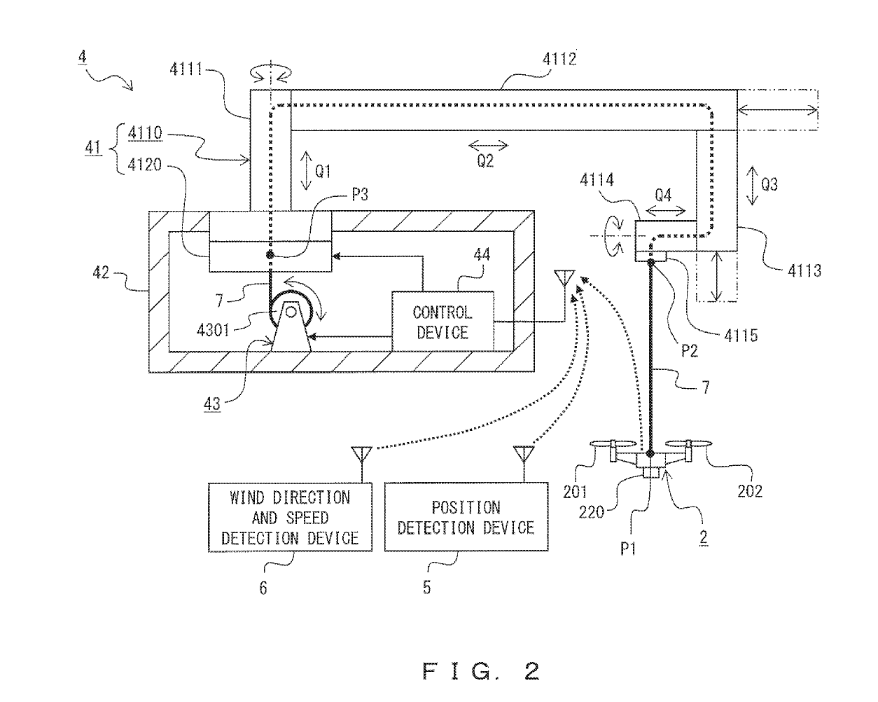

FIG. 2 illustrates a configuration of a crane device according to an embodiment.

As illustrated in FIG. 2, the crane device 4 according to the present embodiment includes a fulcrum position adjustment mechanism 41, a mechanism holding unit 42, a cable winding device 43 and a control device 44.

The fulcrum position adjustment mechanism 41 adjusts the fulcrum position on the crane device 4 side of the cable 7 connected to the unmanned aerial vehicle 2. The fulcrum position adjustment mechanism 41 includes an arm unit 4110, a pedestal unit 4120 that turnably supports the arm unit 4110, a driving force transmission mechanism (not illustrated) etc. The pedestal unit 4120 is held by the mechanism holding unit 42.

The arm unit 4110 includes a mechanism that can three-dimensionally change a positional relationship between prescribed position P3 in the pedestal unit 4120 and fulcrum position P2 that supports the cable 7 connected to the unmanned aerial vehicle 2. For example, the arm unit 4110 includes four arms, i.e., a first arm 4111, a second arm 4112, a third arm 4113 and a fourth arm 4114.

The first arm 4111 has a substantially pillar-like outline, and an engagement unit is provided at one end of axial directions Q1 of the first arm 4111 in a manner such that axial directions Q1 are the turning axis, the engagement unit being turnably engaged with an arm support unit in the pedestal unit 4120. Also, the second arm 4112 is attached to the other end of the axial direction of the first arm 4111.

The second arm 4112 has a substantially pillar-like outline, and is configured to be extendable in axial directions Q2. The second arm 4112 is attached to the first arm 4111 with its axial directions Q2 in a direction roughly orthogonal to axial directions Q1 of the first arm 4111. The third arm 4113 is attached to the end, of the second arm 4112, that is farther from the connection portion with the first arm 4111.

The third arm 4113 has a substantially pillar-like outline, and is configured to be extendable in axial directions Q3. The third arm 4113 is attached to the second arm 4112 with its axial directions Q3 in a direction roughly orthogonal to axial directions Q2 of the second arm 4112. The fourth arm 4114 is attached to the end, of the third arm 4113, that is farther from the connection portion with the second arm 4112.

The fourth arm 4114 has a substantially pillar-like outline, and is provided with a cable support unit 4115 that supports the cable 7 connected to the unmanned aerial vehicle 2. The fourth arm 4114 is attached to the third arm 4113 with its axial directions Q4 in a direction roughly orthogonal to axial directions Q3 of the third arm 4113. Also, the fourth arm 4114 is attached to the third arm 4113 in such a manner that it can turn on axial directions Q4 as the turning axis. The cable support unit 4115 is configured to be able to change for example the provided cable length of the cable 7, and is configured to support the cable 7 in such a manner that it prevents the provided cable length from being changed when the unmanned aerial vehicle 2 is falling.

The length and the direction of the arm unit 4110 are adjusted by a driving force transmission unit (not illustrated) of the fulcrum position adjustment mechanism 41.

The mechanism holding unit 42 holds the pedestal unit 4120 in the fulcrum position adjustment mechanism 41 and the engagement unit of the first arm 4111.

The cable winding device 43 is provided with a drum 4301 that winds surplus portions of the cable 7 connected to the unmanned aerial vehicle 2, and adjusts the number of times of winding the cable 7 on the drum 4301 so as to adjust the provided cable length. The cable 7 has been drawn out to the internal space of the mechanism holding unit 42 through the cable-pulling-around spaces that are formed respectively in the arms 4111 through 4114 of the arm unit 4110 and in the pedestal unit 4120. The surplus portions of the cable 7 drawn out to the internal space of the mechanism holding unit 42 has been wound by the cable winding device 43 provided in the internal space of the mechanism holding unit 42. Based on a control signal from the control device 44, the cable winding device 43 adjusts the number of times of winding the cable 7, and adjusts the length of the cable 7 (provided cable length) from the cable support unit 4115 of the arm unit 4110 to the unmanned aerial vehicle 2.

The control device 44 controls the operations of the fulcrum position adjustment mechanism 41 and the cable winding device 43 based on the flight position and orientation of the unmanned aerial vehicle 2, the wind direction and wind speed in the environment surrounding the unmanned aerial vehicle 2, and other factors.

Based on the flight position and orientation of the unmanned aerial vehicle 2 etc., the control device 44 determines the position (fulcrum position P2) of the cable support unit 4115 with respect to the flight position in the world coordinate system, and calculates the length and the orientation of each of the arms 4111 through 4114 of the arm unit 4110. The control device 44 generates a control signal including information indicating the length and orientation of each of the arms 4111 through 4114 of the arm unit 4110, and transmits the signal to the fulcrum position adjustment mechanism 41. Based on the control signal from the control device 44, the fulcrum position adjustment mechanism 41 controls the length and orientation of each of the arms 4111 through 4114 of the arm unit 4110.

Also, the control device 44 calculates the provided cable length based on for example the flight orientation of the unmanned aerial vehicle 2, on the direction of fulcrum position P2 (the cable support unit 4115) on the crane device 4 side seen from fulcrum position P1 of the cable 7 in the unmanned aerial vehicle 2, on the distance between the fulcrums, and on other factors. Further, the control device 44 calculates the pulling-around length of the cable 7 from the cable winding device 43 to the cable support unit 4115 based on the length of each of the arms 4111 through 4114 of the arm unit 4110. Based on the calculated provided cable length and pulling-around length, the control device 44 generates a control signal including information indicating the number of times of winding the cable 7 so as to transmit the signal to the cable winding device 43. Based on the control signal from the control device 44, the cable winding device 43 rotates the drum 4301 of the cable winding device 43 and controls the number of times of winding the cable 7.

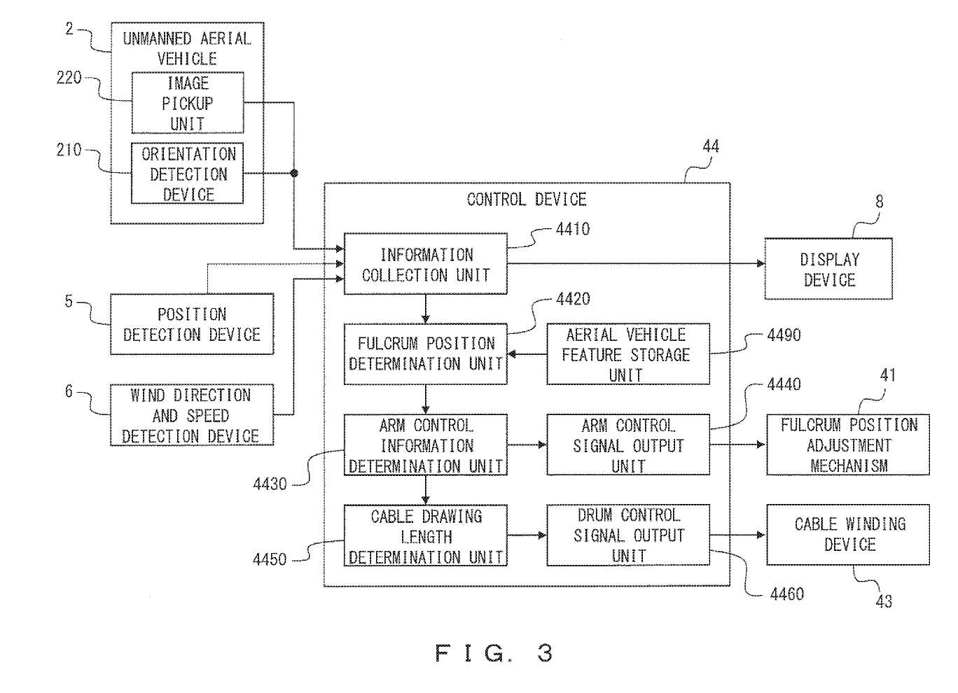

FIG. 3 illustrates a functional configuration of the control device.

As illustrated in FIG. 3, the control device 44 includes an information collection unit 4410, a fulcrum position determination unit 4420, an arm control information determination unit 4430, an arm control signal output unit 4440, a cable drawing length determination unit 4450 and a drum control signal output unit 4460. Also, the control device 44 includes an aerial vehicle feature storage unit 4490.

The information collection unit 4410 collects information such as the flight position and orientation of the unmanned aerial vehicle 2, the wind direction, the wind speed, etc. The information collection unit 4410 for example conducts wireless communications with the position detection device 5 so as to obtain information indicating the flight position of the unmanned aerial vehicle 2. Also, the information collection unit 4410 conducts wireless communications with an orientation detection device 210 of the unmanned aerial vehicle 2 so as to obtain information indicating the orientation of the unmanned aerial vehicle 2. Further, the information collection unit 4410 for example conducts wireless communications with the wind direction and speed detection device 6 so as to obtain information indicating the wind direction and wind speed in the environment surrounding the unmanned aerial vehicle 2 (flight environment).

Note that the information collection unit 4410 may have a function of obtaining an image picked up by an image pickup unit 220 of the unmanned aerial vehicle 2 so as to output the image to a display device 8, in addition to the above function of obtaining (collecting) various types of information.

Based on the flight position and orientation of the unmanned aerial vehicle 2 etc., the fulcrum position determination unit 4420 calculates an appropriate position of the cable support unit 4115 in the arm unit 4110 so as to determine fulcrum position P2 of the cable 7 on the crane device 4 side. The fulcrum position determination unit 4420 first calculates connection position P1 of the cable 7 in the unmanned aerial vehicle 2 based on for example the flight position, and calculates the reference extension direction of the cable 7 based on the orientation. For example the vertically upward direction in the unmanned aerial vehicle 2 while the unmanned aerial vehicle 2 is flying in a correct orientation is treated as the reference extension direction of the cable 7. Thereafter, the fulcrum position determination unit 4420 calculates an appropriate position of the cable support unit 4115 based on the connection position of the cable 7 in the unmanned aerial vehicle 2, the reference extension direction of the cable 7 and the feature amount of the unmanned aerial vehicle 2 stored in the aerial vehicle feature storage unit 4490.

The features of the unmanned aerial vehicle 2 stored in the aerial vehicle feature storage unit 4490 include a scope of angles from the reference extension direction to the cable 7 that are tolerated as an extension direction of the cable 7. The scope of angles is set based on for example connection position P1 of the cable 7 in the unmanned aerial vehicle 2 and the rotation regions of the rotor blades 201 through 204.

The arm control information determination unit 4430 determines the length and direction of the arm of the fulcrum position adjustment mechanism 41 based on the positional relationship between the position of the cable support unit 4115 calculated by the fulcrum position determination unit 4420 and the connection position of the cable 7 in the unmanned aerial vehicle 2 and generates arm control information. The arm control information generated by the arm control information determination unit 4430 is output to the fulcrum position adjustment mechanism 41 by the arm control signal output unit 4440.

Based on the length of the arm of the fulcrum position adjustment mechanism 41 and the distance and direction to the cable connection position of the unmanned aerial vehicle 2 from the cable support unit 4115, the cable drawing length determination unit 4450 calculates and determines the length of the cable to be drawn from the cable winding device 43. The cable drawing length determination unit 4450 calculates the pulling around length of the cable 7 from the cable winding device 43 to the cable support unit 4115 based on the length of the arm of the fulcrum position adjustment mechanism 41. Also, the cable drawing length determination unit 4450 calculates the length of the cable 7 from the cable support unit 4115 to the cable connection position of the unmanned aerial vehicle 2 (provided cable length) based on the distance and direction to the cable connection position of the unmanned aerial vehicle 2 from the cable support unit 4115. The cable drawing length determination unit 4450 determines the sum of the calculated pulling around length of the cable 7 and provided cable length to be the length of the cable 7 that is to be drawn from the cable winding device 43. Information indicating the length, calculated by the cable drawing length determination unit 4450, of the cable 7 to be drawn from the cable winding device 43 is output to the drum control signal output unit 4460.

Based on the information indicating the length, calculated by the cable drawing length determination unit 4450, of the cable 7 to be drawn from the cable winding device 43, the drum control signal output unit 4460 generates a drum control signal that indicates the number of times of winding the cable in the cable winding device 43. The drum control signal output unit 4460 outputs the generated drum control signal to the cable winding device 43. In accordance with the drum control signal, the cable winding device 43 rotates the drum 4301 that has wound the cable 7, and controls the length of the cable 7 drawn from the drum.

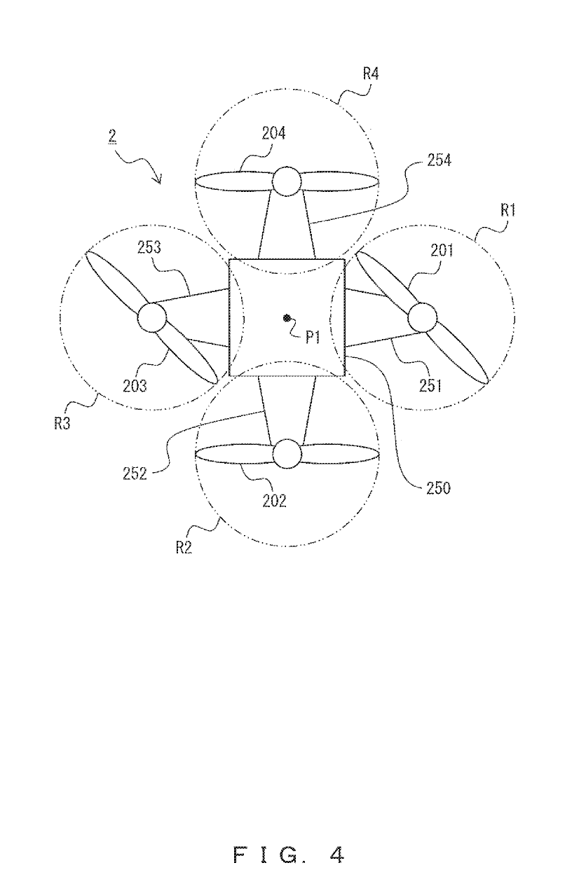

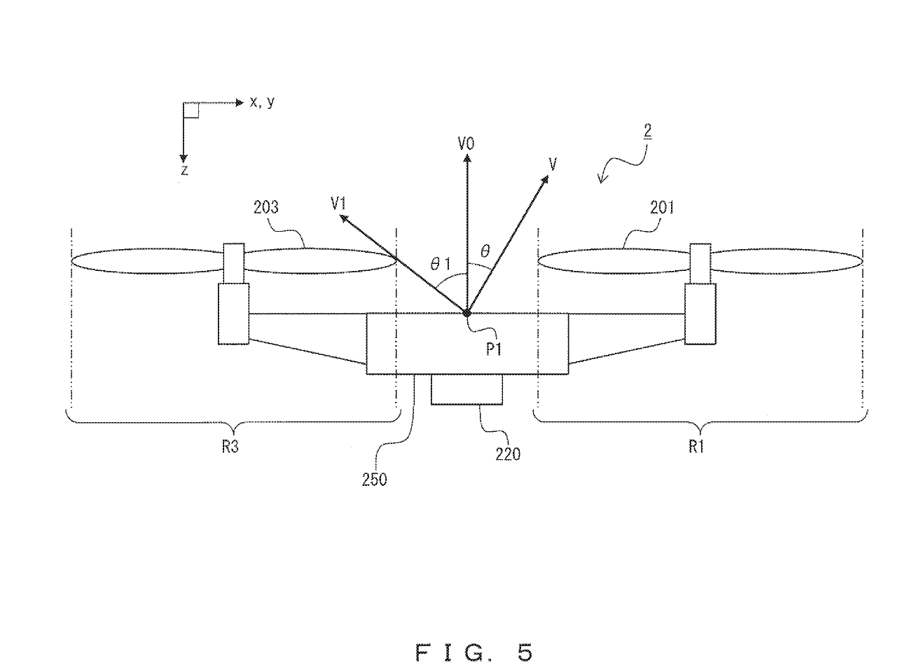

Next, by referring to FIG. 4 and FIG. 5, explanations will be given for an example of a feature of the unmanned aerial vehicle 2 that is to be stored in the aerial vehicle feature storage unit 4490.

FIG. 4 is a plan view explaining a relationship between the rotation regions of the rotor blades in the unmanned aerial vehicle and the cable connection position. FIG. 5 is a front view explaining a relationship between the rotation regions of the rotor blades in the unmanned aerial vehicle and an extension direction of the cable. Note that in the front view illustrated in FIG. 5, the arm portions and rotor blades located on the near and far sides of a casing 250 in the unmanned aerial vehicle 2 are omitted.

As illustrated in FIG. 4 and FIG. 5 for example, the unmanned aerial vehicle 2 in the aerial vehicle operation system 1 according to the present embodiment is provided with for example the casing 250 in which a plurality of arm portions 251, 252, 253 and 254 are formed, rotor blades 201, 202, 203 and 204 that are rotatably supported by the plurality of arm portions 251 through 254, respectively, and image pickup unit 220.

Various types of electronic circuits and electronic components related to flight of the unmanned aerial vehicle 2 are accommodated in the internal spaces of the casing 250 and of the arm portions 251 through 254. For example, a reception unit that receives a control signal from the manipulation unit 3, an orientation detection device that detects the orientation of the unmanned aerial vehicle 2, a motor that rotates the rotor blades, a control unit that controls the number of rotations of the motor, etc. are accommodated in the internal space of the casing 250. Also, a transmission unit that transmits information indicating the orientation of the unmanned aerial vehicle 2, an image picked up by the image pickup unit 220, etc. is accommodated in the internal space of the casing 250.

When the cable 7 for preventing crashing is connected to the unmanned aerial vehicle 2, it is desirable that connection position P1 of the cable 7 be near the center of gravity of the unmanned aerial vehicle 2 on the surface facing vertically upward in the unmanned aerial vehicle 2 in the casing 250 while the unmanned aerial vehicle 2 is flying in a correct orientation. A correct orientation of the unmanned aerial vehicle 2 during flight is an orientation in which an orientation detected by the orientation detection device (such as a gyro sensor for example) provided to the unmanned aerial vehicle 2 indicates that the unmanned aerial vehicle 2 is not inclined. This can make the distance longer between the cable 7 connected to the unmanned aerial vehicle 2 and each of rotation regions R1, R2, R3 and R4 of the rotor blades 201, 202, 203 and 204, and leads to a decrease in the occurrence of a situation in which the cable 7 comes into contact with the rotor blades 201 through 204.

In the present embodiment, for example, the vertically upward direction with respect to connection position P1 of the cable 7 in the unmanned aerial vehicle 2 when it is flying in a correct orientation as illustrated in FIG. 5 is treated as reference extension direction V0. Also, the position of the cable support unit 4115 of the crane device 4 is adjusted so that angle θ between extension direction V of the cable 7 during the flight of the unmanned aerial vehicle 2 and reference extension direction V0 is in a prescribed angle scope. The knowledge of the outer dimensions of the casing 250, rotation regions R1 through R4 of the rotor blades 201 through 204, and the connection position of the cable 7 in the unmanned aerial vehicle 2 makes it possible to calculate angle θ1. Here, angle θ1 is angle between and reference extension direction V0 and extension direction V1 of the cable 7 interfering with rotation regions R1 and R3. Also, while a change in the orientation of the unmanned aerial vehicle 2 causes a change in the direction of reference extension direction V in the world coordinate system, it does not cause a change in angle θ1 of extension direction V1 of the cable 7 interfering with rotation regions R1 and R3 with respect to reference extension direction V0 on the three-dimensional coordinate system in the unmanned aerial vehicle 2. Accordingly, the scope of tolerated angles of extension direction V of the cable 7 during the flight is determined in advance based on the outer dimensions of the casing 250, rotation regions R1 through R4 of the rotor blades 201 through 204, and the connection position of the cable 7 in the unmanned aerial vehicle 2, and the determined scope is stored in the aerial vehicle feature storage unit 4490.

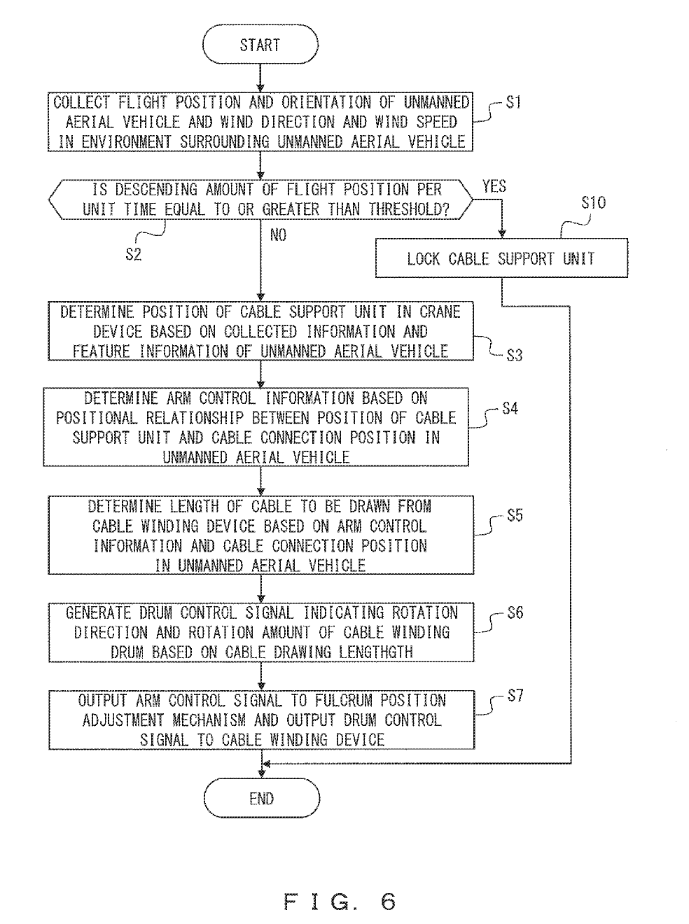

Control of the crane device 4 according to the present embodiment is performed by the control device 44. The control device 44 performs for example the processes based on the flowchart illustrated in FIG. 6 while flying the unmanned aerial vehicle 2.

FIG. 6 is a flowchart illustrating a control method of the crane device according to an embodiment.

The control device 44 in the crane device 4 of the present embodiment first collects the flight position and the flight orientation of the unmanned aerial vehicle 2 as well as the wind direction and wind speed in the environment surrounding the unmanned aerial vehicle 2 (step S1). The process in step S1 is performed by the information collection unit 4410 of the control device 44. The information collection unit 4410 obtains information indicating the flight position of the unmanned aerial vehicle 2 from the position detection device 5 installed in the vicinity of the flight area of the unmanned aerial vehicle 2. Also, the information collection unit 4410 obtains information indicating the orientation of the unmanned aerial vehicle 2 from the orientation detection device provided to the unmanned aerial vehicle 2. Further, the information collection unit 4410 obtains the wind direction and wind speed in the flight environment from the wind direction and speed detection device 6 installed in the vicinity of the flight area of the unmanned aerial vehicle 2.

Next, the control device 44 determines whether or not the descending amount per unit time of the flight position of the unmanned aerial vehicle 2 is equal to or greater than a threshold (step S2). Step S2 is performed by for example the fulcrum position determination unit 4420 of the control device 44. In step S2, the fulcrum position determination unit 4420 calculates the moving direction and the moving amount per unit time of the unmanned aerial vehicle 2 based on the history of the flight position of the unmanned aerial vehicle 2. When the moving direction of the unmanned aerial vehicle 2 is downward and the moving amount per unit time is equal to or greater than a prescribed moving amount, there is a high possibility that the unmanned aerial vehicle 2 has entered an unflyable state and is falling (has crashed). Accordingly, when the descending amount of the flight position per unit time is equal to or greater than a threshold (YES in step S2), the fulcrum position determination unit 4420 locks the cable support unit 4115 (step S10) so as to prevent a change in the provided cable length of the cable 7. This leads to a situation in which the falling unmanned aerial vehicle 2 is suspended from the crane device 4, avoiding damage that would be caused when the unmanned aerial vehicle 2 crashes.

When the descending amount of the flight position per unit time is smaller than the threshold (NO in step S2), the control device 44 next determines the position of the cable support unit 4115 based on information such as the flight position and orientation of the unmanned aerial vehicle 2 and feature information of the unmanned aerial vehicle (step S3). The process in step S3 is performed by the fulcrum position determination unit 4420 of the control device 44. For example, the fulcrum position determination unit 4420 calculates cable connection position P1 in the unmanned aerial vehicle 2 and reference extension direction V0 based on the flight position and orientation of the unmanned aerial vehicle 2. Thereafter, the fulcrum position determination unit 4420 determines an appropriate position (fulcrum position P2) of the cable support unit 4115 based on the feature information (a scope of angles that are tolerated as extension direction V of the cable 7) of the unmanned aerial vehicle, the wind direction, the wind speed, etc., the feature information being stored in the aerial vehicle feature storage unit 4490. For example, the fulcrum position determination unit 4420 estimates, based on the wind direction and wind speed, the moving direction and moving amount of the unmanned aerial vehicle 2 that are related to wind, and determines the position of the cable support unit 4115 in such a manner that the cable 7 will not interfere with the rotation regions of the rotor blades even when wind moves the unmanned aerial vehicle 2. The fulcrum position determination unit 4420 determines, to be the position of the cable support unit 4115, one of positions that are on an extended line in a direction in which the possibility of angle θ with respect to reference extension direction V1 becoming θ1 is low even when wind moves the unmanned aerial vehicle 2.

Next, the control device 44 determines arm control information, which indicates the length and direction of each arm in the arm unit 4110, based on a positional relationship between the position of the cable support unit 4115 determined in step S3 and a cable connection position in the unmanned aerial vehicle 2 (step S4). The process in step S4 is performed by the arm control information determination unit 4430 of the control device 44. For example, arm control information determination unit 4430 first calculates a turning angle of the fourth arm 4114 at which the cable support unit 4115 is in the direction of the cable connection position of the unmanned aerial vehicle 2, based on a positional relationship between the position of the cable support unit 4115 and cable connection position P1 in the unmanned aerial vehicle 2. Thereafter, the cable support unit 4115 calculates the axial direction and length of the second arm 4112 and the length of the third arm 4113 based on the position of the cable support unit 4115, the position of the pedestal unit 4120, and the movable range of each arm of the arm unit 4110. In this process, the arm control information determination unit 4430 calculates for example the length and direction of each arm that results in a minimum change from the current length and direction of each arm, and determines this to be the arm control information. The arm control information determination unit 4430 reports the determined arm control information to the arm control signal output unit 4440 and the cable drawing length determination unit 4450.

Next, the control device 44 determines the length of the cable 7 to be drawn from the cable winding device 43 (cable drawing length) based on the arm control information determined in step S4 and the cable connection position in the unmanned aerial vehicle 2 (step S5). The process in step S5 is performed by the cable drawing length determination unit 4450. The cable drawing length determination unit 4450 calculates the pulling around length of the cable 7 from the cable winding device 43 to the cable support unit 4115 of the arm unit 4110 based on the length of each arm included in the arm control information. Also, the cable drawing length determination unit 4450 calculates the provided cable length from the cable support unit 4115 to the cable connection position in the unmanned aerial vehicle 2 based on a positional relationship between the position of the cable support unit 4115 and cable connection position P1 in the unmanned aerial vehicle 2. The provided cable length is set to be slightly longer than the distance from the position of the cable support unit 4115 to the cable connection position in the unmanned aerial vehicle 2 so that for example tension of the cable will not make the flight of the unmanned aerial vehicle 2 unstable. Note that the provided cable length is set in such a manner that angle θ between extension direction V of the cable 7 and reference extension direction V0 in the vicinity of cable connection position P1 in the unmanned aerial vehicle 2 is within a scope of tolerated angles. The cable drawing length determination unit 4450 reports the sum of the pulling around length of the cable and the provided cable length to the drum control signal output unit 4460 as the cable drawing length.

Next, the control device 44 generates a drum control signal indicating the rotation direction and the rotation amount of the cable winding drum of the cable winding device 43 based on the cable drawing length (step S6). The process in step S6 is performed by the drum control signal output unit 4460. The drum control signal output unit 4460 calculates the rotation direction and the rotation amount (angle) of the drum based on the length of the circumference of the cable winding drum, the drawing length of the cable determined in step S4, and the current drawing length of the cable, and generates a drum control signal including the information obtained from the calculation.

Next, the control device 44 outputs the arm control signal to the fulcrum position adjustment mechanism 41, and outputs the drum control signal to the cable winding device 43 (step S7). The process in step S7 is performed by the arm control signal output unit 4440 and the drum control signal output unit 4460. The arm control signal output unit 4440 generates an arm control signal including arm control information, and outputs the signal to the fulcrum position adjustment mechanism 41. The fulcrum position adjustment mechanism 41 drives each of the arms of the arm unit 4110 and the pedestal unit 4120 in accordance with the arm control signal, and moves the cable support unit 4115 to a prescribed position. The drum control signal output unit 4460 outputs a drum control signal to the cable winding device 43. The cable winding device 43 rotates the drum 4301 in accordance with the drum control signal, and adjusts the amount of the cable 7 drawn from the cable winding device 43 (cable drawn length). This results in an appropriate provided cable length from the cable support unit 4115 of the crane device 4 to the unmanned aerial vehicle 2 and an appropriate extension direction of the cable at the connection position of the cable in the unmanned aerial vehicle 2.

The control device 44 repeats for example the processes in step S1 through step S7 in the flowchart illustrated in FIG. 6, and controls the operation of the fulcrum position adjustment mechanism 41 and the cable winding device 43 of the crane device 4 in response to the flight position, the orientation, etc. of the unmanned aerial vehicle 2, which change continuously. This prevents the occurrence of a situation in which the cable 7 comes into contact with a rotor blade, causing an unstable flight state or a situation in which tension of the cable 7 disturbs the flight orientation, causing an unstable flight state in the aerial vehicle operation system 1. Also, when the unmanned aerial vehicle 2 has become uncontrollable or unflyable and is falling in the aerial vehicle operation system 1, the cable 7 is locked in the cable support unit 4115 so as to prevent a change in the provided cable length. This limits the movable scope of the unmanned aerial vehicle 2, resulting in a situation in which the unmanned aerial vehicle 2 is suspended from the crane device 4, and thereby crashing etc. of the unmanned aerial vehicle 2 is prevented.

Note that the processes in step S1 through step S7 and step S10 illustrated in FIG. 6 may be looped so that a group of the processes in step S1 through step S7 and step S10 is repeated as a single process unit or the processes may be performed in a pipelined manner.

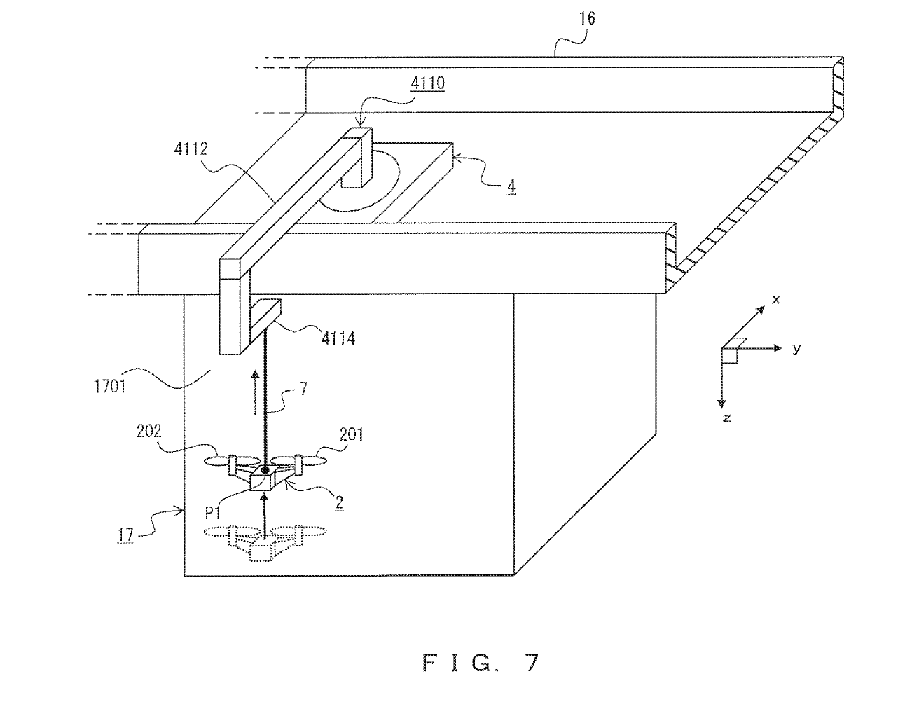

Next, by referring to FIG. 7 through FIG. 9, explanations will be given for the operation of the crane device 4 in response to the flight position etc. of the unmanned aerial vehicle 2 in the aerial vehicle operation system 1 according to the present embodiment.

FIG. 7 explains operations of the crane device in a case when the unmanned aerial vehicle is moved in vertical directions.

FIG. 7 illustrates an example in which the aerial vehicle operation system 1 of the present embodiment is applied to the inspection of a wall surface 1701 of a bridge pier 17 of an elevated bridge (or a bridge) 16 of a road. Because the bridge pier 17 is from several to several tens of meters in height (z-directional dimension) for example, manual inspection of it is troublesome. In view of this, a method has been proposed in recent years in which the image pickup unit 220 is mounted on the unmanned aerial vehicle 2 of a small type such as a drone etc. so as to perform inspection of the bridge pier 17 based on an image of the wall surface 1701 of the bridge pier 17 picked up by the image pickup unit 220. However, when the unmanned aerial vehicle 2 is flown through remote control, there is a possibility that an unexpected factor such as failure, strong winds, etc. for example will force the unmanned aerial vehicle 2 into a state in which stable flight is difficult and cause the crashing of the unmanned aerial vehicle 2. Thus, in inspection of a structure such as the bridge pier 17 etc. through the use of the unmanned aerial vehicle 2, the unmanned aerial vehicle 2 that has entered a state in which stable flight is difficult is suspended by the cable 7 from the crane device 4 for example so as to prevent the crashing of the unmanned aerial vehicle 2.

In a case when the cable 7 is used to prevent the crashing of the unmanned aerial vehicle 2 as described above, when tension of the cable 7 is large during the flight of the unmanned aerial vehicle 2, the unmanned aerial vehicle 2 may be pulled by the cable 7, making the orientation of the unmanned aerial vehicle 2 unstable. Also, when a longer cable is used as the cable 7, slack emerges in the cable 7, leading to a possibility that the cable 7 will come into contact with the rotor blade 201 or 202 of the unmanned aerial vehicle 2 to make the orientation of the unmanned aerial vehicle 2 unstable. Accordingly, in the aerial vehicle operation system 1 according to the present embodiment, the length of the cable 7 (provided cable length) and the extension direction of the cable 7 are controlled based on the flight position and orientation of the unmanned aerial vehicle 2 and the wind direction and wind speed in the surrounding environment.

For example, a case is assumed as illustrated in FIG. 7 in which the unmanned aerial vehicle 2 is made to ascend vertically upward from the position of the unmanned aerial vehicle 2 depicted by the dotted lines. In such a case, when the provided cable length of the cable 7 that is provided from the crane device 4 is consistent, the slack of the cable 7 becomes greater as the unmanned aerial vehicle 2 ascends. This leads to a high possibility that the loosened cable 7 will come into contact with the rotor blade 201 or 202 of the unmanned aerial vehicle 2, making the orientation of the unmanned aerial vehicle 2 unstable.

When, by contrast, the unmanned aerial vehicle 2 ascends vertically upward, the provided cable length of the cable 7 that is provided from the crane device 4 is shortened based on the flight position and orientation etc. of the unmanned aerial vehicle 2 in the aerial vehicle operation system 1 of present embodiment. This makes it possible to suppress slack of the cable 7 and also makes it possible to prevent a situation in which contact between the cable 7 and the rotor blade 201 or 202 of the unmanned aerial vehicle 2 makes the orientation of the unmanned aerial vehicle 2 unstable.

Also, when the unmanned aerial vehicle 2 descends vertically downward, whether or not to continue the provision of the cable 7 is determined based on the amount of a temporal change in the flight position of the unmanned aerial vehicle 2 (step S2) in the aerial vehicle operation system 1, although this is not illustrated in the drawings. When the unmanned aerial vehicle 2 is descending as intended by the controlling person, the provided cable length of the cable 7, which is provided from the crane device 4, is made longer, based on the flight position and orientation etc. of the unmanned aerial vehicle 2. This suppresses an increase in tension of the cable 7, preventing a situation in which the orientation of the unmanned aerial vehicle 2 is made unstable with the unmanned aerial vehicle 2 being pulled by the cable 7. When, by contrast, the unmanned aerial vehicle 2 has entered an uncontrollable or unflyable state and is falling, the provision of the cable 7 is stopped so as to prevent the crashing of the unmanned aerial vehicle 2.

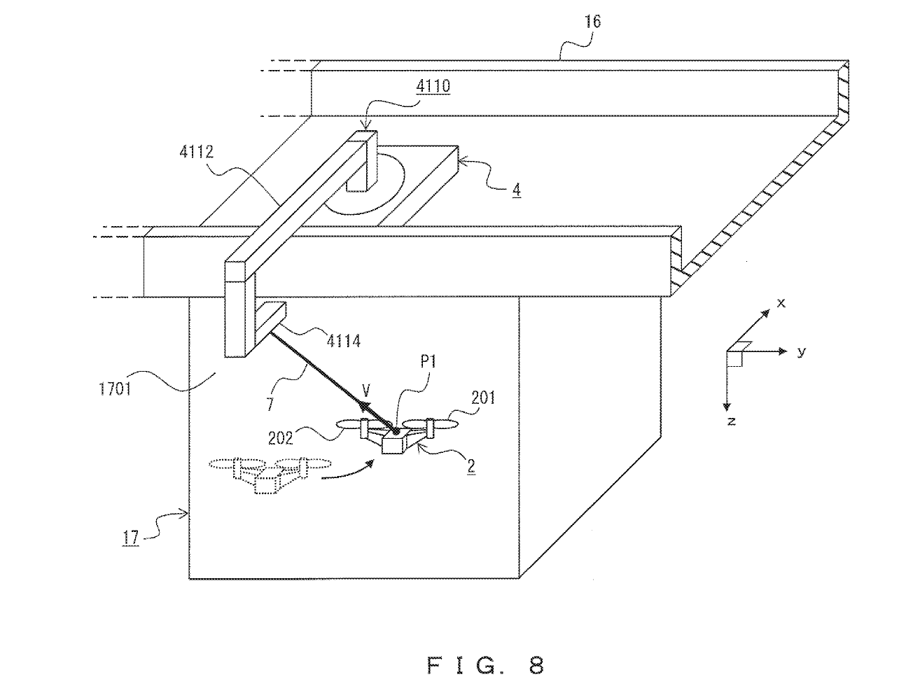

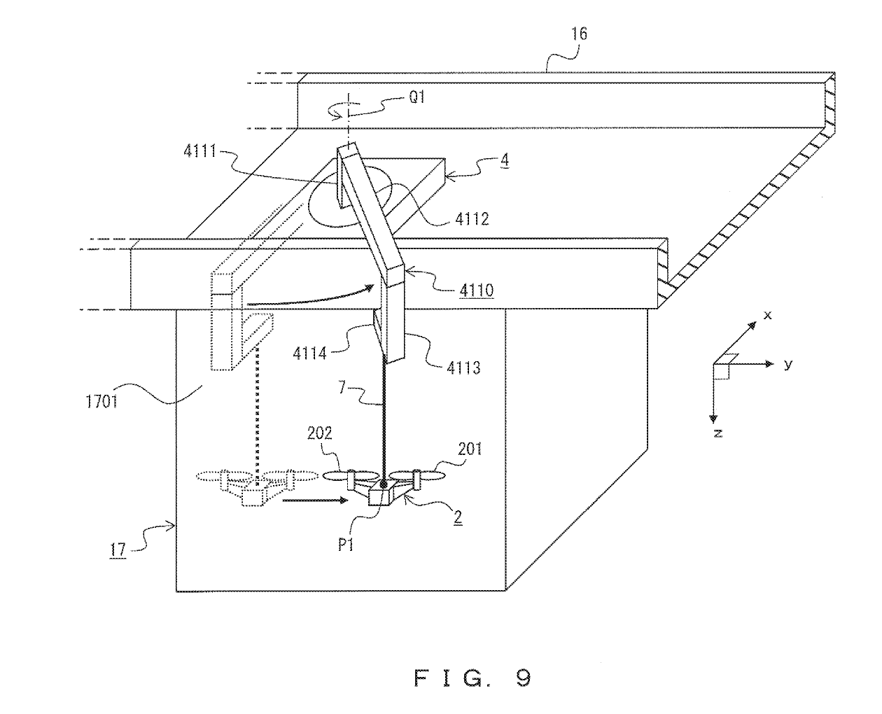

FIG. 8 explains a situation that may occur when arms do not follow horizontal movements of the unmanned aerial vehicle. FIG. 9 explains operations of the crane device in a case when the unmanned aerial vehicle moves in horizontal directions in the aerial vehicle operation system according to an embodiment.

In the control of the unmanned aerial vehicle 2 in the aerial vehicle operation system 1 according to the present embodiment, the unmanned aerial vehicle 2 can be moved in horizontal directions in addition to being made to ascend or descend. Further, because the unmanned aerial vehicle 2 is light in weight, it may be moved by wind in horizontal directions. In other words, the unmanned aerial vehicle 2 may move in a horizontal direction from the position of the unmanned aerial vehicle 2, depicted by the dotted lines for example in FIG. 8, during inspection of the wall surface 1701 of the bridge pier 17. In such a case, when the provided cable length of the cable 7 is equal to that with the flight position of the unmanned aerial vehicle 2 being at the position of the unmanned aerial vehicle 2 depicted by the dotted lines and the arm unit 4110 of the fulcrum position adjustment mechanism 41 is fixed, the cable 7 restricts movement of the unmanned aerial vehicle 2 in horizontal directions. This leads to a possibility for example that a diagonally upward movement of the unmanned aerial vehicle 2 will change extension direction V of the cable 7 so as to bring the cable 7 into contact with the rotor blade 202 of the unmanned aerial vehicle 2. There is also a possibility that the tension of the cable 7 will increase, making the flight orientation of the unmanned aerial vehicle 2 unstable.

In view of this, when the unmanned aerial vehicle 2 moves in horizontal directions, the arm unit 4110 in the crane device 4 turns in the horizontal plane based on information such as the flight position and orientation etc. of the unmanned aerial vehicle 2 as illustrated in FIG. 9 in the aerial vehicle operation system 1. In doing so, the crane device 4 turns the second arm 4112 while changing the length in the axial direction of the second arm 4112 in the arm unit 4110 in such a manner for example that a cable support unit (not illustrated) in the arm unit 4110 follows the flight path of the unmanned aerial vehicle 2 in the horizontal plane. This prevents contact between the cable 7 and the rotor blades of the unmanned aerial vehicle 2 and also prevents tension of the cable 7 from making the flight orientation of the unmanned aerial vehicle 2 unstable. Accordingly, even when the bridge pier 17 has a great width (y-directional dimension), it is possible to fly the unmanned aerial vehicle 2 in a manner of raster scanning and to efficiently obtain an image of the wall surface 1701 of the bridge pier 17. Also, by for example mounting the crane device 4 on a ground vehicle so as to pick up images through the image-pickup device of the unmanned aerial vehicle 2 while changing the position of the ground vehicle, it is further possible to efficiently pick up an image of the wall surface 1701 of the bridge pier 17 having a greater width or images of the wall surfaces 1701 of a plurality of bridge piers.

As described above, the cable 7 provided from the crane device 4 that is installed above the unmanned aerial vehicle 2 is connected to a surface facing upward in the unmanned aerial vehicle 2 while it is flying in a correct orientation in the aerial vehicle operation system 1 according to the present embodiment. In doing so, the crane device 4 adjusts the length of the provided cable 7 in such a manner that extension direction V is a direction in which the cable 7 will not come into contact with a rotor blade of the unmanned aerial vehicle 2, based on a positional relationship between the cable support unit 4115 and cable connection position of the unmanned aerial vehicle 2. Thus, according to the present embodiment, contact between the cable 7 and a rotor blade of the unmanned aerial vehicle 2 is prevented, making it possible for the unmanned aerial vehicle 2 to fly stably.

Also, in the present embodiment, when the descending amount of the unmanned aerial vehicle 2 per unit time is equal to or greater than a threshold (i.e., when the unmanned aerial vehicle 2 is falling at a speed equal to or greater than a prescribed speed), the cable support unit 4115 locks the cable 7 so as to prevent an increase in the provided cable length. Thus, in the present embodiment, when the unmanned aerial vehicle 2 enters an unflyable state, the unmanned aerial vehicle 2 is supported in a state in which it is suspended from the crane device 4 and the crashing of the unmanned aerial vehicle 2 is prevented.

Also, the control method of the crane device 4 according to the present embodiment suppresses contact between the cable 7 and a rotor blade of the unmanned aerial vehicle 2 that may be caused by a change in the extension direction of the cable 7 in the connection portion with the unmanned aerial vehicle 2 in a case when wind etc. moves the unmanned aerial vehicle 2 in an unexpected direction. Also, the position of the cable support unit 4115 and the provided cable length are controlled so as to suppress an increase in the tension of the cable 7, preventing a situation in which a force received from the cable 7 makes the flight orientation of the unmanned aerial vehicle 2 unstable.

Note that the present embodiment describes an example in which the wall surface 1101 of the structure 11 (the wall surface 1701 of the bridge pier 17) is inspected based on an image picked up by the image pickup unit 220 mounted on the unmanned aerial vehicle 2. However, for example a different measurement apparatus such as a measurement apparatus utilizing ultrasonic waves, etc. may be mounted on the unmanned aerial vehicle 2 instead of the image pickup unit 220 for the inspection of the wall surface 1101 of the structure 11 (the wall surface 1701 of the bridge pier 17) conducted by the unmanned aerial vehicle 2. Further, one or a plurality of types of measurement apparatuses may be mounted on the unmanned aerial vehicle 2 in addition to the image pickup unit 220.

Also, in the aerial vehicle operation system 1 according to the present embodiment, the position detection device 5 that detects the flight position of the unmanned aerial vehicle 2 and the wind direction and speed detection device 6 that detects the wind direction and wind speed in the flight environment for example may be embedded in the arm unit 4110 of the crane device 4.

Also, the flowchart illustrated in FIG. 6 is just an example of the control method of the crane device 4 in the aerial vehicle operation system 1 according to the present embodiment. Changes could be made as needed to the control method of the crane device 4 without departing from the spirit of the present embodiment. For example, when the unmanned aerial vehicle 2 is provided with an acceleration sensor and the control device 44 obtains a sensor value of that acceleration sensor, the determination in step S2 may be performed based on that sensor value.

Further, the aerial vehicle operation system 1 according to the present embodiment may be applied to various applications in which the unmanned aerial vehicle 2 is flown in a prescribed flight area, in addition to the above inspection of the structure 11 including the bridge pier 17. For example, the aerial vehicle operation system 1 according to the present embodiment may be applied to an application in which the unmanned aerial vehicle 2 is flown in an environment that is not affected by wind, such as an indoor environment etc. When the unmanned aerial vehicle 2 is flown in an indoor environment, the wind direction and speed detection device 6 may be omitted from the aerial vehicle operation system 1.

Also, the aerial vehicle operation system 1 illustrated in FIG. 1 is just an example of a system configuration of the aerial vehicle operation system according to the present embodiment. For example, the aerial vehicle operation system 1 according to the present embodiment may perform the control of the unmanned aerial vehicle 2, the obtainment of the orientation information etc. by using a signal line that is employed as the cable 7 connected to the unmanned aerial vehicle 2.

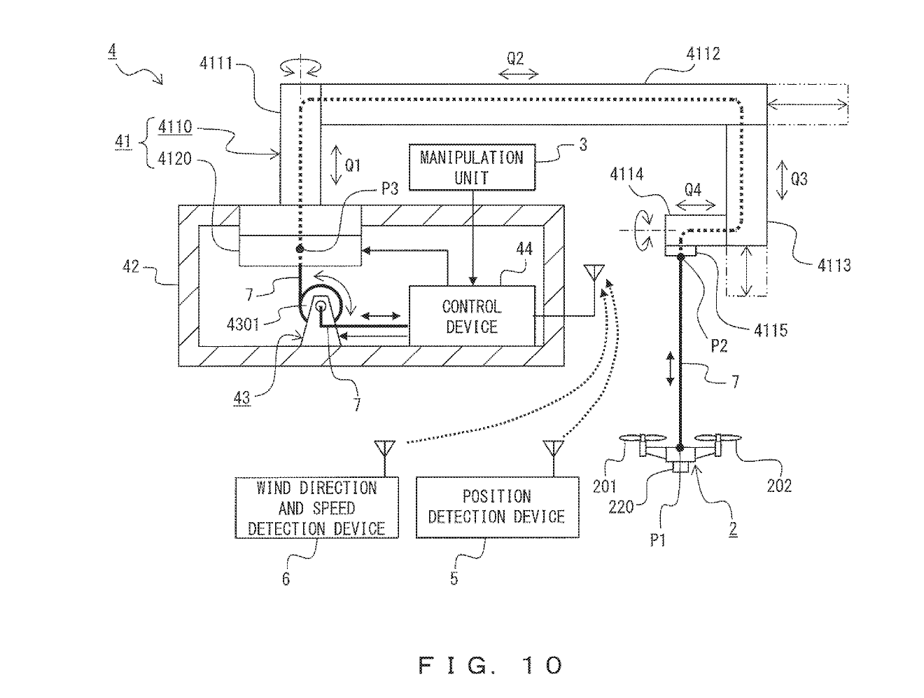

FIG. 10 explains a variation example of the configuration of the crane device.

As illustrated in FIG. 10, the crane device 4 according to the variation example includes the fulcrum position adjustment mechanism 41, the mechanism holding unit 42, the cable winding device 43 and the control device 44. The fulcrum position adjustment mechanism 41, the mechanism holding unit 42 and the cable winding device 43 in the crane device 4 according to the variation example respectively have the above configurations and functions.

By contrast, the control device 44 in the crane device 4 according to the variation example obtains a signal related to the control of the unmanned aerial vehicle 2 from the manipulation unit 3, and transmits that signal to the unmanned aerial vehicle 2 via the cable 7. Also, the control device 44 obtains, via the cable 7, information indicating the orientation of the unmanned aerial vehicle 2 detected by the unmanned aerial vehicle 2, an image picked up by the image pickup unit 220 mounted on the unmanned aerial vehicle 2, and other pieces of information. Further, the control device 44, as described above, obtains information indicating the flight position of the unmanned aerial vehicle 2 from the position detection device 5 and information indicating the wind direction and wind speed in the flight environment from the wind direction and speed detection device 6.

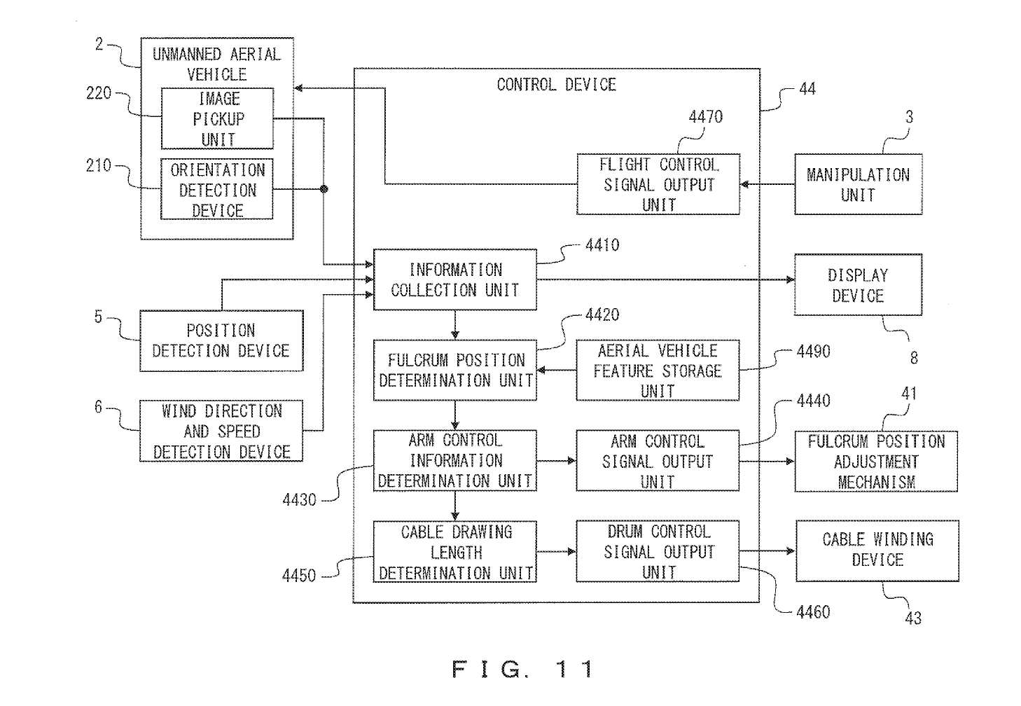

The control device 44 in the crane device 4 according to the present variation example employs for example a functional configuration as illustrated in FIG. 11. FIG. 11 illustrates a functional configuration of a control device according to the variation example.

As illustrated in FIG. 11, the control device 44 according to the variation example includes the information collection unit 4410, the fulcrum position determination unit 4420, the arm control information determination unit 4430, the arm control signal output unit 4440, the cable drawing length determination unit 4450 and the drum control signal output unit 4460. The constituents 4410 through 4460 in the control device 44 according to the variation example respectively have the above described functions. Also, the aerial vehicle feature storage unit 4490 in the control device 44 according to the variation example stores feature information about the unmanned aerial vehicle 2 that includes information indicating an angle tolerated as an extension direction of the cable 7, which was explained by referring to FIG. 4 and FIG. 5.

Also, the control device 44 according to the variation example further includes a flight control signal output unit 4470 in addition to the above constituents 4410 through 4460 and 4490. The flight control signal output unit 4470 obtains, from the manipulation unit 3, a signal in response to manipulations on the manipulation unit 3 given by the person who is controlling the unmanned aerial vehicle 2, and outputs the signal obtained from the manipulation unit 3 to the unmanned aerial vehicle via the cable 7.

As illustrated in FIG. 10 and FIG. 11, the unmanned aerial vehicle 2 is controlled by using the cable 7 as a signal line, and thereby signals related to the control for example are input from the manipulation unit 3 to the unmanned aerial vehicle 2 more securely. This suppresses a situation in which the unmanned aerial vehicle 2 moves in an unexpected direction and thereby enters an uncontrollable state. Also, controlling the unmanned aerial vehicle 2 by using the cable 7 as a signal line reduces the power consumption in the unmanned aerial vehicle 2 in comparison with a case of using wireless communications, leading to a longer continuous flight time for the unmanned aerial vehicle 2.

Also, in the aerial vehicle operation system 1 according to the variation example as well, when the unmanned aerial vehicle 2 is flown in an environment that is not affected by wind, such as an indoor environment etc., the wind direction and speed detection device 6 may be omitted.

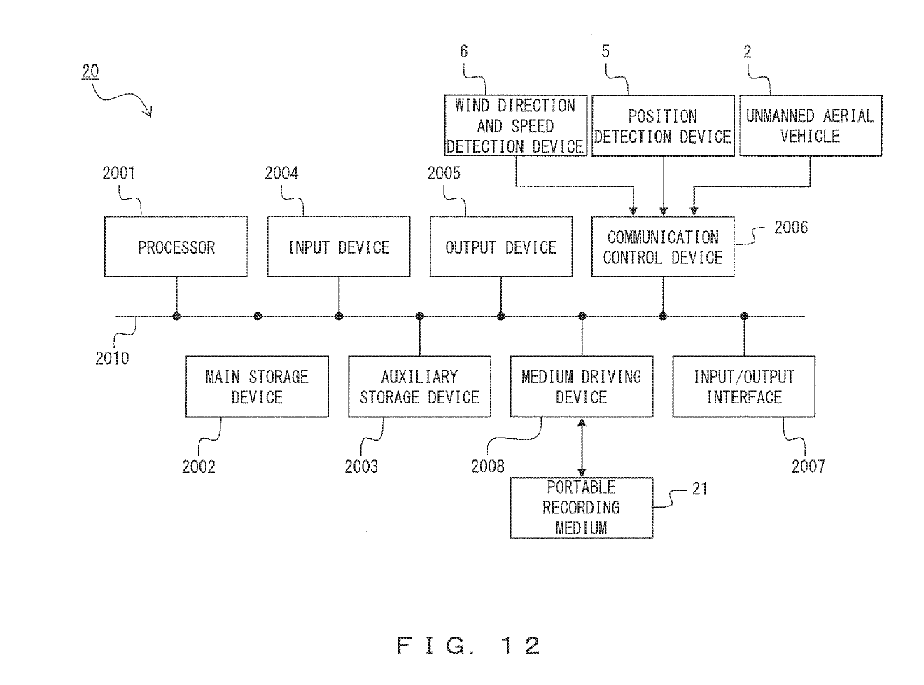

The control device 44 of the crane device 4 in the aerial vehicle operation system 1 according to the above embodiments may be implemented by a computer and a control program that is executed by the computer. Hereinbelow, by referring to FIG. 12, explanations will be given for the control device 44 that is implemented by a computer and a control program.

FIG. 12 illustrates a hardware configuration of a computer.

As illustrated in FIG. 12, the computer 20 includes a processor 2001, a main storage device 2002, an auxiliary storage device 2003, an input device 2004, an output device 2005, a communication control device 2006, an input/output interface 2007 and a medium driving device 2008. These elements 2001 through 2008 in the computer 20 are connected to each other via a bus 2010 so that data can be exchanged between the elements.

The processor 2001 is for example a Central Processing Unit (CPU), a Micro Processing Unit (MPU), etc. The processor 2001 executes various types of programs including an operating system so as to control the entire operation of the computer 20. Also, the processor 2001 executes for example a control program for controlling operations of the crane device 4, the control program including the processes of the flowchart of FIG. 6.

The main storage device 2002 includes a Read Only Memory (ROM) and a Random Access Memory (RAM) (not illustrated). The ROM of the main storage device 2002 has stored in advance for example a prescribed basic control program etc. that is read by the processor 2001 upon the activation of the computer 20. Meanwhile, the RAM of the main storage device 2002 is used as a working storage region as needed when the processor 2001 executes the various types of programs. The RAM of the main storage device 2002 can be used for storing for example feature information of the aerial vehicle including information indicating a scope of tolerated angles of an extension direction of the cable 7, the position of the cable support unit 4115, the direction and length of each arm in the arm unit 4110, etc.

The auxiliary storage device 2003 is a storage device of a volume larger than that of the RAM of the main storage device 2002 and is a Hard Disk Drive (HDD), a non-volatile memory (including a Solid State Drive (SSD)) such as a flash memory, etc. The auxiliary storage device 2003 can be used for storing various types of programs executed by the processor 2001 and various types of data, etc. The auxiliary storage device 2003 can be used for storing for example a control program for controlling operations of the crane device 4, the control program including the processes of the flowchart of FIG. 6. For example, the auxiliary storage device 2003 can be used for storing feature information of the aerial vehicle including information indicating a scope of tolerated angles of an extension direction of the cable 7, the position of the cable support unit 4115, the direction and length of each arm in the arm unit 4110, etc. Further, the auxiliary storage device 2003 can be used for storing for example the flight history of the unmanned aerial vehicle 2, an image picked up by the image pickup unit 220 attached to the unmanned aerial vehicle 2, a measurement result obtained by a measurement device attached to the unmanned aerial vehicle 2, etc.

The input device 2004 is for example a keyboard device, a touch panel device, etc. When the operator (user) of the computer 20 conducts a prescribed manipulation on the input device 2004, the input device 2004 transmits input information associated with that manipulation to the processor 2001. The input device 2004 can be used for for example inputting an activation order of the crane device 4, inputting and editing feature information of the unmanned aerial vehicle 2, etc. Also, in the control device 44 according to the variation example, which uses the cable 7 as a signal line (see FIG. 10 and FIG. 11), the input device 2004 can be used as the manipulation unit 3 of the unmanned aerial vehicle 2.

The output device 2005 is for example a display device such as a liquid crystal display device etc. or a printing device such as a printer etc. The output device 2005 can be used for displaying the operation status of the computer 20, displaying an image picked up by the image pickup unit 220 attached to the unmanned aerial vehicle 2, displaying and printing a flight history, and for other purposes.

The communication control device 2006 is a device that controls, according to prescribed communication schemes, various types of communications between the computer 20 and other communication devices. The communication control device 2006 can be used for for example performing wireless or wired communications with each of the unmanned aerial vehicle 2 (the orientation detection device 210) and the position detection device 5 so as to obtain (collect) information needed to control the operation of the crane device 4. The communication control device 2006 performs communications with the unmanned aerial vehicle 2 (the orientation detection device 210) so as to obtain information indicating the orientation of the unmanned aerial vehicle 2. Also, the communication control device 2006 obtains information indicating the flight position of the unmanned aerial vehicle 2 from the position detection device 5. Further, when the aerial vehicle operation system 1 includes the wind direction and speed detection device 6, the communication control device 2006 performs wired or wireless communications with the wind direction and speed detection device 6 as well so as to obtain information indicating the wind direction and wind speed in the flight environment of the unmanned aerial vehicle 2.

The input/output interface 2007 connects the computer 20 and other electronic devices. The input/output interface 2007 is provided with a connector that is compatible with for example the Universal Serial Bus (USB) standard. The input/output interface 2007 can be used for connecting for example the computer 20 and the fulcrum position adjustment mechanism 41 of the crane device 4 and connecting the computer 20 and the cable winding device 43 of the crane device 4. Also, the input/output interface 2007 can also be used for connecting for example the computer 20 and each of the position detection device 5 and the wind direction and speed detection device 6. Further, in the control device 44 according to the variation example, which uses the cable 7 as a signal line (see FIG. 10 and FIG. 11), the input/output interface 2007 can be used for connecting the computer 20 and the unmanned aerial vehicle 2 via the cable 7.

The medium driving device 2008 reads a program and data stored in a portable storage medium 21, and writes, to the portable storage medium 21, data etc. stored in the auxiliary storage device 2003. A memory card reader/writer compatible with one or a plurality of standards for example can be used as the medium driving device 2008. When a memory card reader/writer is used as the medium driving device 2008, a memory card (flash memory) etc. that is compatible with a standard with which the memory card reader/writer is compatible, such as the Secure Digital (SD) standard for example, can be used as the portable storage medium 21. Also, a flash memory etc. having a USB-compatible connector for example can be used as the portable storage medium 21. Further, when the computer 20 is provided with an optical disk drive that can be used as the medium driving device 2008, various types of optical disks that can be recognized by that optical disk drive can be used as the portable storage medium 21. Examples of an optical disk that can be used as the portable storage medium 21 include a Compact Disc (CD), a Digital Versatile Disc (DVD), a Blu-ray Disc (registered trademark), etc. The portable storage medium 21 can be used for storing for example a control program for controlling operations of the crane device 4, the control program including the processes of the flowchart of FIG. 6. For example, the portable storage medium 21 can be used for storing feature information of the aerial vehicle including information indicating the scope of tolerated angles of an extension direction of the cable 7, the position of the cable support unit 4115, the direction and length of each arm in the arm unit 4110, etc. Further, the portable storage medium 21 can be used for storing for example the flight history of the unmanned aerial vehicle 2, an image picked up by the image pickup unit 220 attached to the unmanned aerial vehicle 2, a measurement result obtained by a measurement device attached to the unmanned aerial vehicle 2, etc.

When the operator of the crane device 4 uses the input device 2004 to input an activation order etc. of the crane device 4 to the computer 20, the processor 2001 reads and executes the control program stored in a non-transitory recording medium such as the auxiliary storage device 2003 etc. While executing the control program, the computer 20 repeats the process of the flowchart of FIG. 6 at time intervals that are set in advance. Specifically, the computer 20 collects the flight position and orientation of the unmanned aerial vehicle 2 as well as the wind direction and wind speed, and adjusts (controls) the position of the cable support unit 4115 of the crane device 4 and the provided cable length based on the collected pieces of information. While executing the control program, the communication control device 2006 functions (operates) as the information collection unit 4410 in the control device 44. Also, while executing the control program, the processor 2001 functions as the fulcrum position determination unit 4420, the arm control information determination unit 4430 and the cable drawing length determination unit 4450 in the control device 44. Further, while executing the control program, the processor 2001 cooperates with the input/output interface so as to function (operate) as the arm control signal output unit 4440 and the drum control signal output unit 4460.

Also, while executing the control program, the RAM of the main storage device 2002, the auxiliary storage device 2003, etc. function as storage units, including the arm control signal output unit 4440, that store various types of information.

Note that the computer 20 that is made to operate as the control device 44 does not have to include all the elements 2001 through 2008 illustrated in FIG. 12, and some of the elements may be omitted in accordance with usage or conditions. For example, the computer 20 may omit the medium driving device 2008. Also, when information such as the flight position and orientation of the unmanned aerial vehicle 2, the wind direction, the wind speed, etc. is collected via the input/output interface 2007, the computer 20 may omit the communication control device 2006.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An aerial vehicle operation system comprising:
an unmanned aerial vehicle in which a cable is connected to a surface facing upward during flight in a correct orientation;
a memory;
a processor that is connected to the memory and that is configured to perform a process comprising:
collecting flight position and orientation of the unmanned aerial vehicle;
determining, based on the flight position and orientation of the unmanned aerial vehicle, a fulcrum position at which to support the cable to be above the unmanned aerial vehicle and to be on an extended line in a direction within a prescribed scope of angles with respect to a reference extension direction in the unmanned aerial vehicle;
determining, based on the determined fulcrum position, control information about an operation of an arm in a crane device that includes a cable support supporting the cable and the arm changing a position of the cable support; and
determining a length of a cable from the fulcrum position to a connection position of the cable in the unmanned aerial vehicle based on a positional relationship between the determined fulcrum position and the connection position of the cable in the unmanned aerial vehicle and based on a positional relationship between the connection position of the cable in the unmanned aerial vehicle and a rotation region of a rotor blade of the unmanned aerial vehicle;
a fulcrum position adjustment mechanism configured to control an operation of the arm based on the determined control information about an operation of the arm; and
a cable winding device configured to change, based on the determined length of the cable, a length of the cable provided from the cable support.

2. The aerial vehicle operation system according to claim 1, wherein
the reference extension direction in the unmanned aerial vehicle is a vertically upward direction in the unmanned aerial vehicle during flight in a correct orientation, and
the fulcrum position at which to support the cable is determined to be on an extended line in a direction within a scope of tolerated angles of an extension direction of the cable that is set in advance based on an angle between an extension direction of the cable in which the cable connected to the unmanned aerial vehicle comes into contact with the rotor blade and the reference extension direction.

3. The aerial vehicle operation system according to claim 1, wherein
information indicating the flight position of the unmanned aerial vehicle is obtained from a position detection device set in a vicinity of a flight area of the unmanned aerial vehicle and information indicating the orientation of the unmanned aerial vehicle is obtained from an orientation detection device included in the unmanned aerial vehicle.

4. The aerial vehicle operation system according to claim 1, wherein
the processor further obtains information including a wind direction and a wind speed in an environment surrounding the unmanned aerial vehicle, and
the fulcrum position at which to support the cable is determined based on the flight position and orientation of the unmanned aerial vehicle as well as the wind direction and the wind speed.

5. The aerial vehicle operation system according to claim 1, wherein
the cable includes a signal line, and
information indicating the orientation of the unmanned aerial vehicle is obtained via the signal line.

6. The aerial vehicle operation system according to claim 1, wherein
the cable includes a first signal line connecting a manipulation device for controlling the unmanned aerial vehicle and the unmanned aerial vehicle, and a second signal line connecting the processor and the unmanned aerial vehicle, and
information indicating the orientation of the unmanned aerial vehicle is obtained via the second signal line.

7. The aerial vehicle operation system according to claim 1, wherein
the crane device includes an arm that is extendable in axial directions and an arm that is turnable on axial directions as a turning axis, and
the control information including a length of the extendable arm and a turning angle of the turnable arm is determined in the determination of the control information.

8. The aerial vehicle operation system according to claim 1, wherein
the processor, before determining the fulcrum position, calculates a moving direction and a moving amount per unit time of the unmanned aerial vehicle based on a temporal change in the flight position of the unmanned aerial vehicle, and prevents the cable winding device from changing a length of the cable provided from the cable support when a descending amount of the unmanned aerial vehicle per unit time is equal to or greater than a threshold.

9. A crane device control method including a process executed by a computer, the process comprising:
collecting flight position and orientation of an unmanned aerial vehicle in which a cable is connected to a surface facing upward during flight in a correct orientation;
determining, based on the flight position and orientation of the unmanned aerial vehicle, a fulcrum position at which to support the cable to be above the unmanned aerial vehicle and to be on an extended line in a direction within a prescribed scope of angles with respect to a reference extension direction in the unmanned aerial vehicle;
determining, based on the determined fulcrum position, control information about an operation of an arm in a crane device that includes a cable support supporting the cable and the arm changing a position of the cable support;
determining a length of a cable from the fulcrum position to a connection position of the cable in the unmanned aerial vehicle based on a positional relationship between the determined fulcrum position and the connection position of the cable in the unmanned aerial vehicle and based on a positional relationship between the connection position of the cable in the unmanned aerial vehicle and a rotation region of a rotor blade of the unmanned aerial vehicle; and
making the crane device control an operation of the arm based on the determined control information about an operation of the arm and making the crane device change a length of the cable provided from the cable support, based on the determined length of the cable.

10. The crane device control method according to claim 9, wherein
the reference extension direction in the unmanned aerial vehicle is a vertically upward direction in the unmanned aerial vehicle during flight in a correct orientation, and
the fulcrum position at which to support the cable is determined to be on an extended line in a direction within a scope of tolerated angles of an extension direction of the cable that is set in advance based on an angle between an extension direction of the cable in which the cable connected to the unmanned aerial vehicle comes into contact with the rotor blade and the reference extension direction.

11. The crane device control method according to claim 9, wherein
the process further includes obtaining information including a wind direction and a wind speed in an environment surrounding the unmanned aerial vehicle, and
the fulcrum position at which to support the cable is determined based on the flight position and orientation of the unmanned aerial vehicle as well as the wind direction and the wind speed.

12. The crane device control method according to claim 9, wherein
the crane device includes an arm that is extendable in axial directions and an arm that is turnable on axial directions as a turning axis, and
the control information including a length of the extendable arm and a turning angle of the turnable arm is determined in the determination of the control information.

13. The crane device control method according to claim 9, wherein
the process further includes calculating, before determining the fulcrum position, a moving direction and a moving amount per unit time of the unmanned aerial vehicle based on a temporal change in the flight position of the unmanned aerial vehicle, and preventing the cable winding device from changing a length of the cable provided from the cable support when a descending amount of the unmanned aerial vehicle per unit time is equal to or greater than a threshold.

14. A non-transitory computer-readable recording medium having stored therein a program causing a computer to execute a process comprising:
collecting flight position and orientation of an unmanned aerial vehicle in which a cable is connected to a surface facing upward during flight in a correct orientation;
determining, based on the flight position and orientation of the unmanned aerial vehicle, a fulcrum position at which to support the cable to be above the unmanned aerial vehicle and to be on an extended line in a direction within a prescribed scope of angles with respect to a reference extension direction in the unmanned aerial vehicle;
determining, based on the determined fulcrum position, control information about an operation of an arm in a crane device that includes a cable support supporting the cable and the arm changing a position of the cable support;
determining a length of a cable from the fulcrum position to a connection position of the cable in the unmanned aerial vehicle based on a positional relationship between the determined fulcrum position and the connection position of the cable in the unmanned aerial vehicle and based on a positional relationship between the connection position of the cable in the unmanned aerial vehicle and a rotation region of a rotor blade of the unmanned aerial vehicle; and
making the crane device control an operation of the arm based on the determined control information about an operation of the arm and making the crane device change a length of the cable provided from the cable support, based on the determined length of the cable.
